(19) United States
(12) Patent Application Publication
(10) Pub. No.: US 2005/0287871 A1
(43) Pub. Date: Dec. 29, 2005

(54) Device, method, and program for computer aided design of flexible substrates

(75) Inventors: Takeshi Nakayama, Nishinomiya city (JP); Shin-ichi Tanimoto, Souraku-gun (JP); Yoshiyuki Saito, Katano city (JP)

Correspondence Address: WENDEROTH, LIND & PONACK, L.L.P., 2033 K STREET N. W., SUITE 800, WASHINGTON, DC, 20006-1021, US

(73) Assignee: Matsushita Electric Industrial Co., Ltd.

(21) Appl. No.: 11/156,659

(22) Filed: Jun. 21, 2005

(30) Foreign Application Priority Data
Jun. 25, 2004 (JP) 2004-187702

(51) Int. Cl. H01R 25/00

(52) U.S. Cl. 439/638

(57) ABSTRACT

A device, method, and program too facilitate the design of flexible printed circuit boards is disclosed which generates, as a prohibited space, a position assumed to be occupied by a part on an opposing printed circuit board when the printed circuit board is bent from a bend position. Design preparation of a bendable flexible printed circuit board can be efficiently checked by checking for the presence/absence of interference between parts and prohibited spaces.

### BACKGROUND OF THE INVENTION

1. Field of the Invention

The present invention relates a device for computer aided design of flexible printed circuit boards. More specifically, the present invention relates to computer aided design of bendable flexible printed circuit boards.

2. Background Information

In conventional computer aided design of flexible substrates, the flexible substrate is designed using flat printed circuit board (PCB) computer aided design (CAD).

Japanese Patent Application Publication No. 2002-117082 discloses a device for simulating the mounting of a flexible printed substrate. This device checks whether or not the deformation limit of a part is exceeded when the substrate is deformed, and outputs a message when the deformation limit is exceeded.

FIG. 12 is a flow chart of the process of simulating the mounting of a flexible printed substrate disclosed in Japanese Patent Application Publication No. 2002-117082. The mounting simulation device generates design data displayed on a display device based on flexible substrate configuration information, wiring pattern information, and electronic part layout information, and the like (S901). Then, the mounting simulation device generates bend data for the substrate based on deformation specifications (S902), and checks the deformation limit data of the electronic part (S903). When the deformation limit is exceeded, a warning is output (S904).

Problems of design complexity arise, however, in designs using flat printed circuit board computer aided design which cannot deal with the bending of a substrate, because the designer must specifically verify interference by other parts when the flexible substrate is bent.

The mounting simulation device disclosed in Japanese Patent Application Publication No. 2002-117082 determines whether or not a bent substrate exceeds the deformation limit conditions of the mounted part, and outputs a warning. Therefore, a warning cannot be output for parts which do not exceed the deformation limit conditions, even when it interferes with an opposing part.

In view of the above, it is an object of the present invention to eliminate this problem in the conventional art by providing a computer aided design device which facilitates the design of flexible printed circuit boards. This invention addresses this object as well as other objects, which will become apparent to those skilled in the art from this disclosure.

### SUMMARY OF THE INVENTION

To eliminate the previously described problems, a device for computer aided design of flexible printed circuit boards according to a first aspect of the present invention includes:
a memory unit configured to store parts data, the parts data including at least the positions of a first part and a second part arranged on a flexible printed circuit board as well as the heights thereof;
a prohibited space generating unit that is configured to generate a prohibited space based upon the position of the first part on the flexible printed circuit board, a bend position on the flexible printed circuit board, and the parts data for the first part stored in the memory unit;
a determination unit configured to determine whether or not a design standard violation has occurred based upon the space on the flexible printed circuit board occupied by the second part on the flexible printed circuit board, and the prohibited space; and
an error output unit configured to output an error notification in accordance with the determination result of the determination unit.

This device estimates the position of a part when the flexible printed circuit board is bent at the bend position with the flexible printed circuit board in an unbent state. That is, the position of the part when the flexible printed circuit board is bent is calculated as the prohibited space. The prohibited space generated by a first part is compared to the space occupied by a second part on the printed circuit board. By means of this comparison, when the first part and second part contact one another, or a predetermined clearance is not maintained between the first part and second part, and an error notification is output as a design standard violation. In this way, the interference of parts, such as contact between parts when the flexible printed circuit board is bent, can be easily considered in the design even when the flexible printed circuit board is in an unbent state.

The device for computer aided design of flexible printed circuit boards according to a second aspect of the present invention is the device according to the first aspect, wherein the prohibited space includes a space which will be occupied by at least a portion of the first part when the flexible printed circuit board is bent at the bend position.

The prohibited space has at least the same size as the space occupied by the first part, that is, the same height and planar area. In this way, it is possible to estimate the influence exerted on the surface opposite the first part when the flexible printed circuit board is bent.

The device for computer aided design of flexible printed circuit boards according to a third aspect of the present invention is the device according to the first aspect, wherein the prohibited space generating unit determines the position of the prohibited space based on the direction in which the flexible printed circuit board is to be bent.

The prohibited space is formed on the surfaces which form a trough fold at the bend position. That is, the prohibited space is formed on the mutually opposite surface when the board is bent at the bend position. Therefore, parts which extend from either of the mutually opposed surfaces are prevented from abutting and coming into contact with each other.

The device for computer aided design of flexible printed circuit boards according to a fourth aspect of the present invention is the device according to the first aspect, wherein the output means further outputs data concerning the prohibited space.

By visually outputting the prohibited space, it is possible to aid smooth printed circuit board design by preventing, beforehand, the placement of a new part at a position which will generate a design standard violation. An example of this visual output is a projection of the prohibited space displayed on the printed circuit board.

The device for computer aided design of flexible printed circuit boards according to a fifth aspect of the present invention is the device according to the first aspect, and further includes a bend position receiving unit configured to receive an addition to and/or modification of the bend position on the flexible printed circuit board. The prohibited space generating unit updates the previously generated prohibited space based on the updated bend position, and the determination unit determines whether or not a design standard violation has occurred based upon the updated prohibited space.

This device for computer aided design adds a new bend position, and updates the prohibited space based on the new bend position when the previously specified bend position is modified. The prohibited space is automatically updated in accordance with the update of the bend position, and an alert is generated when a design standard violation occurs in conjunction with the update of the prohibited space. Accordingly, a previously determined bend can be modified, and design standard violations can be corrected even when a bend position is added.

The device for computer aided design of flexible printed circuit boards according to a sixth aspect of the present invention is the device according to the first aspect, and further includes a part position receiving unit configured to receive specifications of new part layout positions on the flexible printed circuit board. The determination unit determines the space occupied by a new part on the flexible printed circuit board, and whether or not a design standard violation has occurred, based upon the pre-existing prohibited space and the space occupied by the new part.

When a new part is installed on the printed circuit board, an error notification is output if the new part is within a previously established prohibited space. In this way placing a new part at a position which will generate a design standard violation can be easily avoided. When a new part is placed outside a pre-existing prohibited space, it is desirable that a new prohibited space is generated at a position of axial symmetry relative to the part centered at the bend position.

The device for computer aided design of flexible printed circuit boards according to a seventh aspect of the present invention is the device according to the first aspect, wherein the prohibited space generating unit generates a prohibited layout area at the position on the flexible printed circuit board at which the generated prohibited space is projected.

When nothing can be placed on the surface opposite a prohibited space when the flexible printed circuit board is bent, it is desirable that a prohibited layout area is generated to prevent placement of a part within that surface area. For example, consider a situation in which a part taller than a fixed height cannot be placed at a planned position opposite a prohibited space, based on the spacing of the flexible printed circuit board when the board is bent, the height of the prohibited space, and the clearance required around the prohibited space. In this situation, it is beneficial to output an error message when the designer intends to place an excessively tall part in the prohibited layout area.

The device for computer aided design of flexible printed circuit boards according to a seventh aspect of the present invention is the device according to the first aspect, wherein the memory unit further stores one or more prohibition conditions which prohibit the layout of a specific type of part. The prohibited space generating unit further generates a prohibited area which prohibits the layout of a specific type of part on the flexible printed circuit board based upon the one or more prohibition conditions and the bend position.

For example, beta wiring, via hole, and wiring pattern bends can be prohibited within a fixed area from the bend position. Smooth designs are possible by generating a prohibited area for parts affected by bending the flexible printed circuit board.

According to a ninth aspect of the present invention, a method for computer aided design of flexible printed circuit boards includes the steps of:
storing parts data that includes at least the positions of a first part and a second part arranged on a flexible printed circuit board as well as the heights thereof;
generating a prohibited space based upon the position of the first part on the flexible printed circuit board, a bend position on the flexible printed circuit board, and the parts data for the first part stored in the memory unit;
determining whether or not a design standard violation has occurred based upon the space on the flexible printed circuit board occupied by the second part on the flexible printed circuit board, and the prohibited space; and
outputting an error notification in accordance with the determination result of the determination unit.

The device executing this method realizes the same effects as the device for computer aided design according to the first aspect.

According to a tenth aspect of the present invention, a computer program product is used to direct a computer to function as a device for computer aided design of flexible printed circuit boards, and includes:
a memory unit configured to store parts data, the parts data including at least the positions of a first part and a second part arranged on a flexible printed circuit board as well as the heights thereof;
a prohibited space generating unit that is configured to generate a prohibited space based upon the position of the first part on the flexible printed circuit board, a bend position on the flexible printed circuit board, and the parts data for the first part stored in the memory unit;
a determination unit configured to determine whether or not a design standard violation has occurred based upon the space on the flexible printed circuit board occupied by the second part on the flexible printed circuit board, and the prohibited space; and
an error output unit configured to output an error notification in accordance with the determination result of the determination unit.

The computer executing this program realizes the same effects as the device for computer aided design of the first invention.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a structural diagram of the functions of the computer aided design device;

FIG. 2i shows an example of printed circuit board information;

FIG. 2a shows an example of a part name list;

FIG. 2b shows an example of a part number list;

FIG. 2d shows an example of layout information;

FIG. 2e shows an example of a terminal list;

FIG. 2f shows an example of part-to-terminal connection information;

FIG. 2g shows an example of block information; FIG. 2h shows an example of printed circuit board shape information;

FIG. 2j shows an example of bend line information;

FIG. 2k shows another example of bend line information;

FIG. 3 is an example of an error notification screen output by the output unit;

FIG. 4a shows prohibited space generated from a part;

FIG. 4b shows a prohibited area generated from FIG. 4a;

FIG. 5a shows interference between a part and a prohibited space;

FIG. 5b shows a prohibited area generated from FIG. 5a;

FIG. 6a shows a generated prohibited area;

FIG. 6b shows a prohibited area generated from FIG. 6a;

FIG. 7 is a flow chart showing an example of the flow of the main routine;

FIG. 8 is a flow chart showing an example of the processing flow of the prohibited space generation process;

FIG. 9 is a flow chart showing an example of the flow of the bend position modification process;

FIG. 10 is a flow chart showing an example of the flow of the prohibited area generation process;

FIG. 11a shows the three-dimensional overlap of a planar beta wiring prohibited area and planar beta wiring;

FIG. 11b shows a plane view of part of the planar beta wiring converted to grid wiring data; and

FIG. 12 is a flow chart showing the process performed by a conventional device for simulating mounting of flexible printed circuit board.

### DETAILED DESCRIPTION OF THE PREFERRED EMBODIMENTS

The embodiments of the present invention are described hereinafter with reference to the drawings. The embodiments hereinafter described are specific examples of the present invention and do not in any way limit the technical scope of the invention.

### First Embodiment

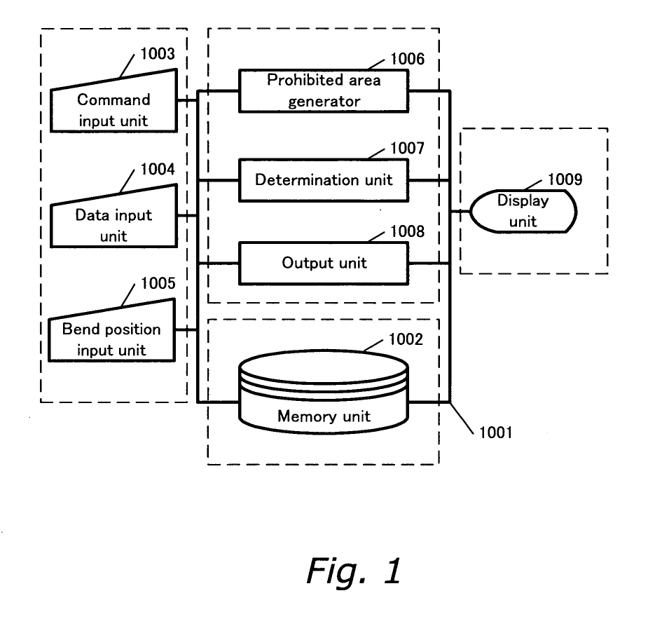

1. Structure 1-1. General Structure FIG. 1 shows a structural diagram of the functions of a device for computer aided design of the present embodiment. A computer aided design device 1001 is equivalent to a CAD system used for PCB (printed circuit board) layout design. The layout designer creates layout data using this device.

The computer aided design device 1001 includes a memory unit 1002, command input unit 1003, data input unit 1004, bend position input unit 1005, prohibited area generator 1006, determination unit 1007, and output unit 1008. The computer aided design device 1001 is connected to a display unit 1009 which provides a display. The computer aided design device 1001 is achieved by a computer provided with hardware such as a CPU, ROM, RAM, and a memory device. The functions of each part are specifically described below.

1-2 Memory Unit

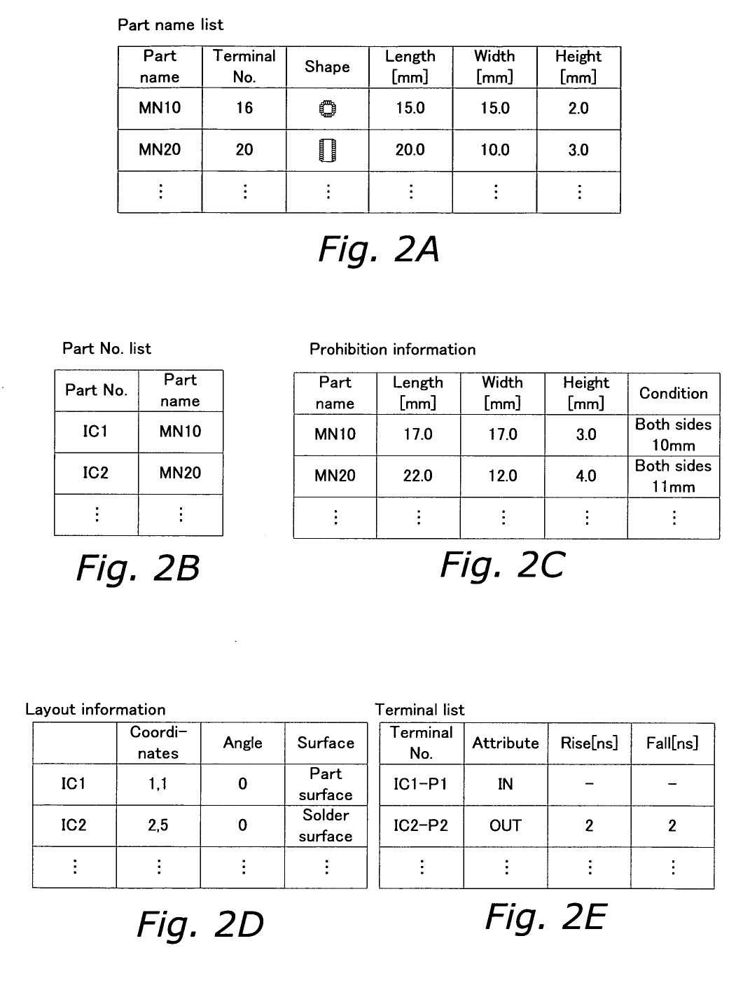

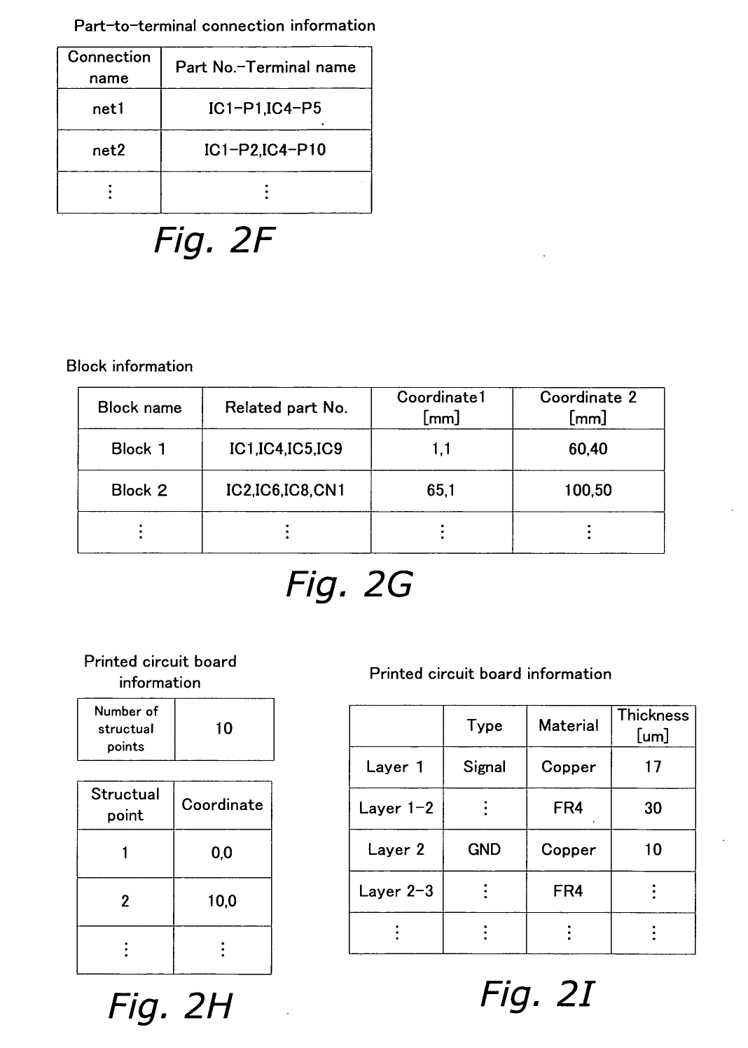

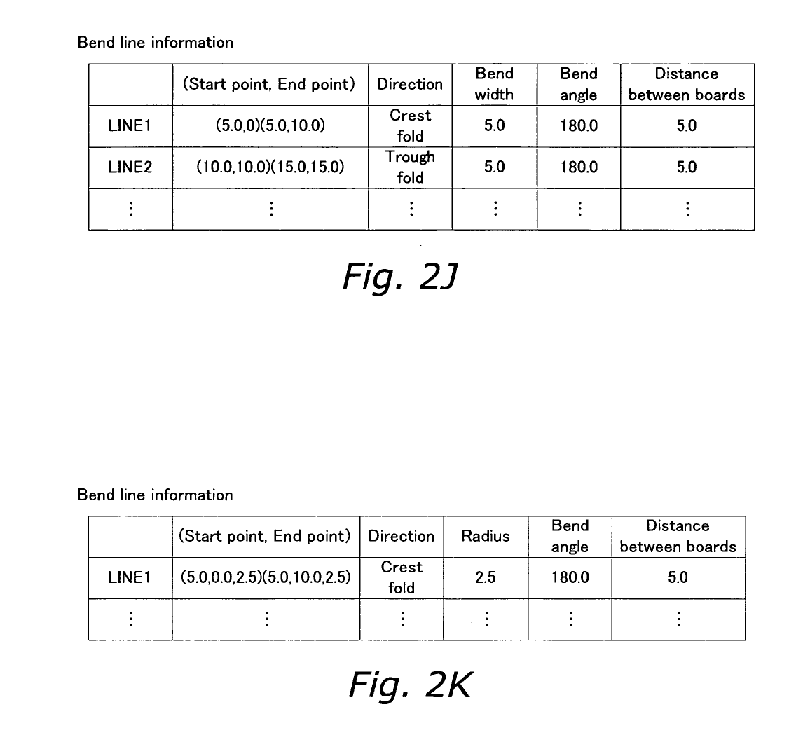

The memory unit 1002 stores design data including part information (equivalent to part data), prohibition information (equivalent to prohibition data), layout information, design standard information, printed circuit board information and the like. FIG. 2 shows an example of a portion of the design data stored in the memory unit 1002. The memory unit 1002 stores prohibited space data and prohibited area data (described below).

The part information includes a part name list and part number list. The part name list shown in FIG. 2a includes, for example, information such as part configuration which identifies the shape of the part, part classification which identifies the type of part, part standard coordinates which represent the layout position of the part, part layout surface which identifies the surface on which the part is laid out, part height which represents the height of the part, and the electrical characteristics of the part. Part configuration includes the dimensions of the part. The part number list shown in FIG. 2b stores the part numbers which identify the name of the part installed on the PCB.

Prohibition information includes the part name or prohibition type for the part type, the shape of the space or region in which part layout is prohibited, and prohibition conditions which represent the conditions which generate the prohibition. FIG. 2c shows an example of prohibition information. As shown in the drawing, a space or region which adds a margin to the external shape of a part may be defined for each part. Furthermore, margins may be provided in advance in the plane direction and height direction as part of the prohibition information, and a layout prohibited area may be calculated for each part. The prohibition information can be used to prevent an unbendable part from being placed at a position which may incur a bend. For example, beta wiring layout can be prevented near a bend position.

The wiring information includes information which identifies whether or not the wiring layout is surface or wire, via hole coordinates, wire width, wire thickness, and the like. When the wiring information specifies wire, the starting/ending coordinates of the wire, wiring layer and like information is included. When the wiring information specifies surface, the number of structural points, structural point coordinates, painting attributes and like information are included in the wiring information.

The design standard information is information such as surfaces where the part placement is possible, angle, part-to-part and wire-to-wire clearance values, and the like.

The layout information shown in FIG. 2d includes part layout position, angle, layout surface, and the like.

The terminal list shown in FIG. 2e includes terminal number, attributes, rise information, fall information and the like. The terminal number identifies one terminal on one part. The attribute represents the property the terminal has. The rise information represents the signal rise time (nano) when the corresponding attribute is [OUT]. The fall information represents the signal fall time (nano) when the corresponding attribute is [OUT].

The part-to-terminal connection information shown in FIG. 2f includes connection name, and part number-terminal name. The part-to-terminal connection information represents information on one terminal of one part, and the connection between one terminal and one part or another part.

The block information shown in FIG. 2g includes block name, the part number belonging to the part, block coordinates, and the like.

The printed circuit board shape information shown in FIG. 2h includes the number of structural points forming the shape of the board, and the coordinates of each point.

The printed circuit board information shown in FIG. 2i includes the structure of the layer of the PCB, dimensions, electrical characteristics of the material forming the structure of the PCB and the like.

The bend line information shown in FIG. 2j includes the bend position on the flexible printed circuit board, direction, bend width, bend angle, distance between printed circuit boards when bent, and the like.

FIG. 2k shows another example of bend line information. In this example, the bend line information is defined by bend curve position, direction, radius, bend angle, distance between printed circuit boards, and the like.

1-3 Command Input Unit

The command input unit 1003 receives commands input when the user operates an input device such as a keyboard and mouse. Commands include, for example, a draw command and layout check command. The draw command specifies the part layout and wiring pattern on the PCB layout diagram. The layout check command specifies a check of the created layout.

1-4 Data Input Unit and Bend Position Input Unit

The data input unit 1004 receives design data input and writes the data to the memory unit 1002.

The bend position input unit 1005 receives specifications such as the bend position and bend direction input when the user operates an input device such as a keyboard and mouse, and writes the bend line information to the memory unit 1002. There is a crest fold and a trough fold in the bend direction. The bend position input unit 1005 is capable of receiving additional bend positions on the flexible printed circuit board. The bend position input unit 1005 also receives modifications of previously input bend positions.

1-5 Prohibited Area Generator

The prohibited area generator 1006 generates prohibited space based on the layout on the flexible printed circuit board or the position of a first part arranged on the flexible printed circuit board, the bend position of the flexible printed circuit board, and the part information of the first part. For example, it is desirable that the prohibited area generator 1006 generates prohibited space in accordance with empty space input data of the command input unit 1003. For example, the prohibited area generator 1006 generates a prohibited space of corresponding height when the user places a part using the command input unit 1004 and specifies that the height of the part is 2 mm.

When the bend position is updated, the prohibited area generator 1006 calculates the coordinates of a new prohibited space based on the updated bend position. The prohibited area generator 1006 also can generate a prohibited area at the position of the generated prohibited space projected on the flexible printed circuit board. The prohibited area generator 1006 may also generate a layout prohibited area on the flexible printed circuit board based on the bend information and predetermined prohibition information. Prohibited space data which include the coordinates defining the prohibited space, and prohibited area data which include the coordinates defining the prohibited area, are written to the memory unit 1002.

More specifically, when the flexible printed circuit board is bent at the bend position, the prohibited area generator 1006 specifies the space relatively occupied by a first part on the opposite surface as prohibited space. The prohibited area generator 1006 further determines the position, that is, the coordinates, of the prohibited space based on the bend direction. The functions of the prohibited area generator 1006 are described in detail below.

1-6 Determination Unit

The determination unit 1007 determines whether or not to generate a design standard violation based on the prohibited space formed by the first part, and the space occupied on the flexible printed circuit board by a second part other than the first part. When a bend position is added or modified, the determination unit 1007 determines whether or not to generate a design standard violation based on the updated prohibited space. When a new part is arranged on the flexible printed circuit board by the command input unit 1002, it is desirable that the determination unit 1007 determines whether or not to generate a design standard violation based on the pre-existing prohibited space, and the space occupied by the proposed part on the flexible printed circuit board.

1-7 Output Unit

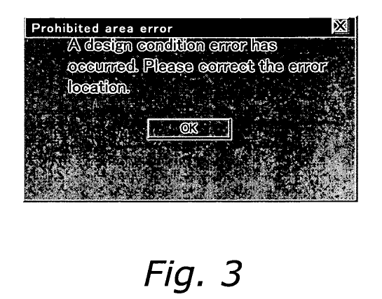

The output unit 1008 outputs an error notification in accordance with the determination result of the determination unit 1007. The error notification may be output as text, sound, and the like. FIG. 3 shows an example of an error notification screen output by the output unit 1008. The output unit 1008 also may output the position of the prohibited space associated with the position of the part on the flexible printed circuit board. For example, it is desirable that the output unit 1008 outputs the region of the prohibited space projected on the flexible printed circuit board as a prohibited area. An example of the prohibited area output is described in detail later.

2. Prohibited Area Generator and Output Unit

2-1 Prohibited Space and Area Generation and Displays

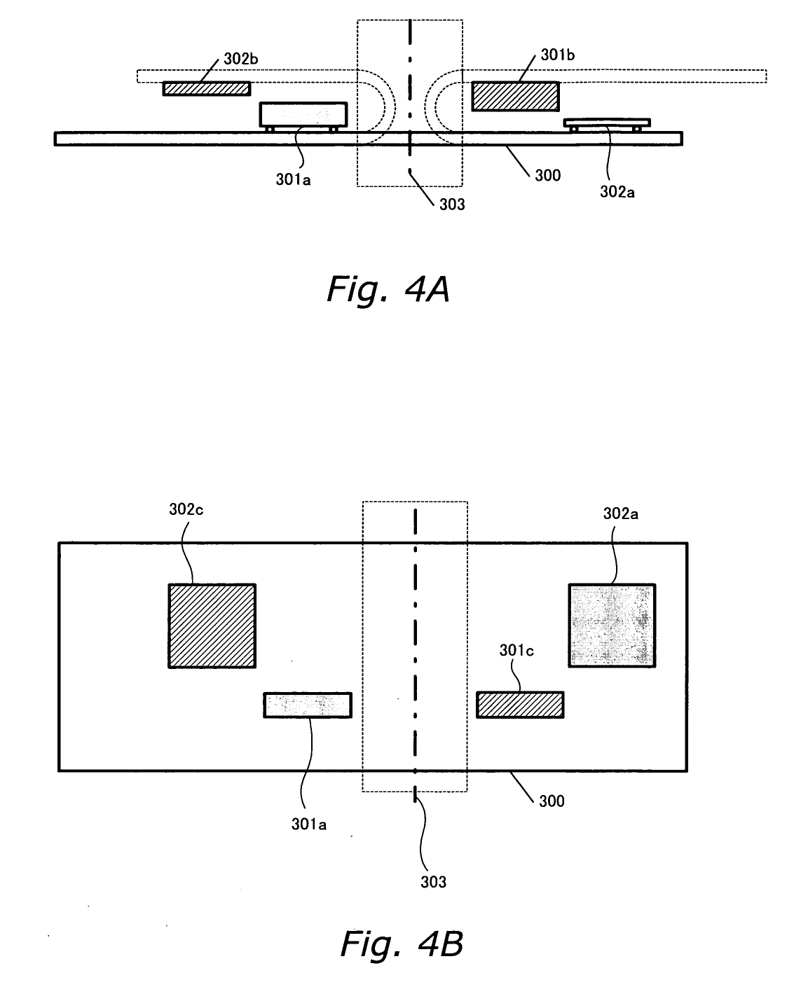

FIG. 4a illustrates prohibited space generated by a part. A bend position 303 is specified on a flexible printed circuit board 300. If a part 301a is viewed as a first part, a prohibited space 301b is generated from the first part 301a. If a part 302a is viewed as a first part, a prohibited space 302b is generated from the first part 302a. When the flexible printed circuit board 300 is bent at the bend position 303, the prohibited space 301b is the relative position of the part 301a on the opposite surface 303b. Similarly, when the flexible printed circuit board 300 is bent at the bend position 303, the prohibited space 302b is the relative position of the part 302a on the opposite surface 303a.

FIG. 4b shows an example of a display of the prohibited areas 301c and 302c when the generated prohibited spaces 301b and 302b are projected on the flexible printed circuit board. The prohibited areas 301c and 302c are formed on mutually opposite surfaces when the bend is performed. The prohibited areas 301c and 302c are formed relative to the parts 301a and 302a at axially symmetrical positions centered on the bend position 303.

It is desirable that the output unit 1008 displays the prohibited areas 301c and 302c together with the part positions on the flexible printed circuit board 300. In this case, the output unit 1008 may change the display color and hatching pattern of the prohibited areas according to the height of the part. Furthermore, the output unit 1008 may display only prohibited areas which interfere with parts when parts are moved.

2-2 Prohibited Space and Part Interference

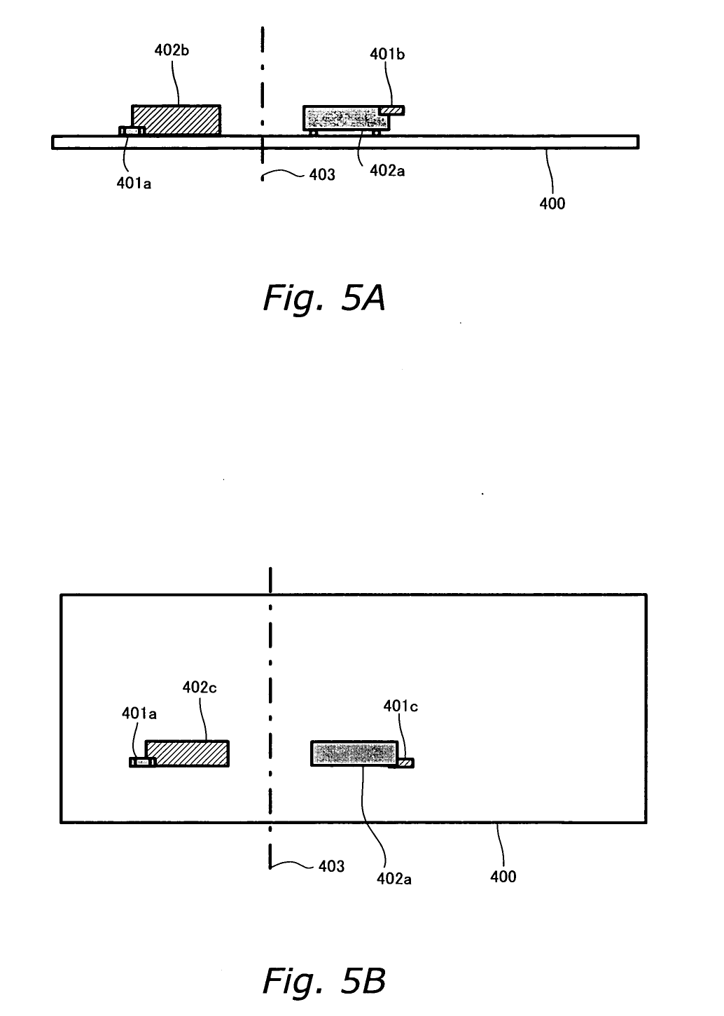

FIG. 5a illustrates interference between a prohibited space and a part. A bend position 403 is specified on a flexible printed circuit board 400. If a part 401a is viewed as a first part, a prohibited space 401b is generated from the first part 401a. If the part 402a is viewed as a first part, a prohibited space 402b is generated from the first part 402a. The part 401a and the prohibited space 402b overlap. Similarly, the part 402a and the prohibited space 401b overlap.

FIG. 5b is an example of a display of the prohibited areas 401c and 402c when the generated prohibited spaces 401b and 402b are projected on the flexible printed circuit board. The prohibited area 402c overlaps the part 401a. Similarly, the prohibited area 401c overlaps the part 402a.

When a situation such as this occurs, the output unit 1008 outputs an error notification.

2-3 Prohibited Area Based on Prohibition Information

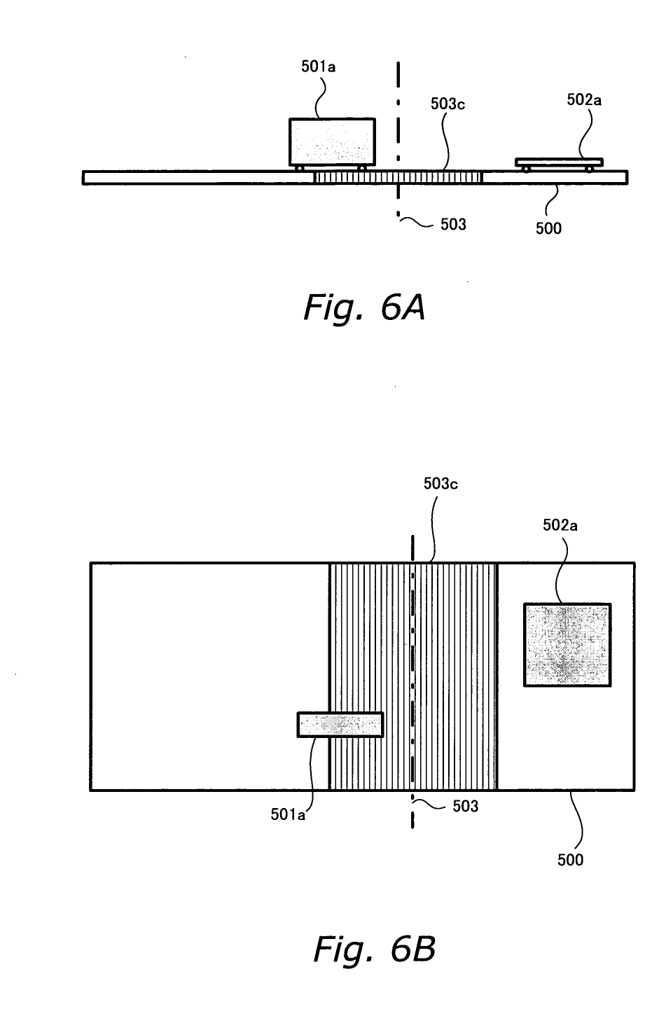

FIGS. 6a and 6b show a generated prohibited area 503c. To simplify the description, an example of a prohibited area 503c for prohibiting beta wiring is described.

When a bend position 503 is input, the prohibited area generator 1006 reads the prohibition information, and generates prohibited area matching the prohibition conditions for each type prohibition. In this example, the prohibition type is beta wiring prohibition, and the prohibition conduction is 10 mm. In this case, the prohibited area generator 1006 sets a region 20 mm in width across the flexible printed circuit board 500 centered on the bend position 503 as the beta wiring prohibited area 503c.

The output unit 1008 outputs, for example, the prohibited area 503c shown in FIG. 6b to the display unit 1009. If the generated prohibited area 503c and the beta wiring overlap as shown, the output unit 1008 outputs an error notification as previously described.

3. Processing

The processing flow executed by the device for computer aided design shown in FIG. 1 is described below. The computer aided design device 1001 independently executes three processes including a main routine, bend position modification process, and prohibited area generation process.

3-1 Main Routine

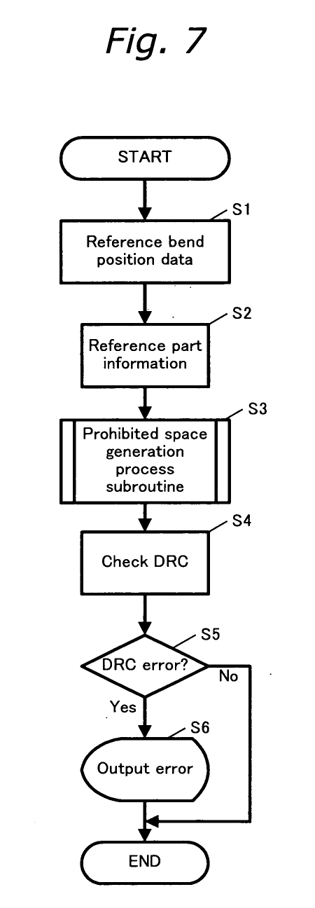

FIG. 7 is a flow chart showing an example of the main routine flow executed by the computer aided design device. When new part information and new bend line information are input, the following process is started. To simplify the description below, the example describes the input of new part information.

Steps S1˜S3: First, the prohibited area generator 1006 reads the input bend line information from the memory unit 1002 (S1). The dimensions of the parts arranged on the trough fold surface are read from the memory unit 102 (S2). The prohibited area generator 1006 generates a prohibited space for each part at a position axially symmetrical with each part centered on the bend line (prohibited space generation process subroutine) (S3). The prohibited space data which include the part type and prohibited space coordinates defining the generated prohibited space are written to the memory unit 1002.

Step S4: the determination unit 1007 reads the prohibited space data, and part information from the memory unit 1002, and determines whether or not the design standards are satisfied, such as the presence or absence of three-dimensional overlap of any prohibited space and any part.

Steps S5˜S6: When the determination unit 1007 determines that the design standards are not satisfied (S5), the output unit 1008 outputs an error notification specifying that the design standards are not satisfied (S6). It is desirable that the output unit 1008 outputs the generated prohibited area and layout of the parts and printed circuit board stored in the memory unit 1002 to the display unit 1009 before the error notification. When the determination unit 1007 does not determine a design standard violation, this process ends.

According to the above structure, if a user specifies a bend position on the printed circuit board, the presence or absence of interference among parts is output, thereby facilitating the user's design of the flexible printed circuit board.

3-2 Prohibited Space Generation Process subroutine

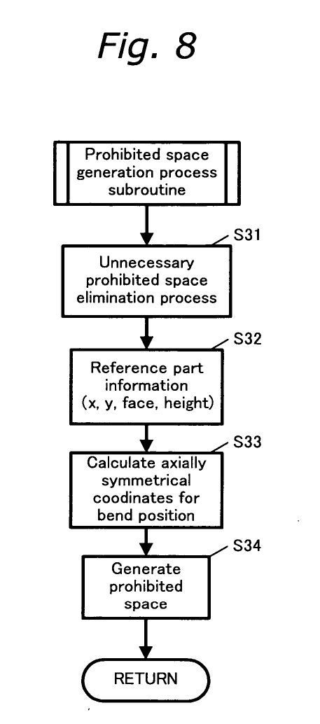

FIG. 8 is a flow chart showing an example of the processing flow of the prohibited space generation process subroutine. When the flow moves to step S3 in the main routine, the following process is started.

Step S31: The prohibited area generator 1006 references the coordinates of the prohibited space written in the memory unit 1002, and eliminates unnecessary prohibited space. For example, when bent at the bend position, prohibited space is unnecessary if formed at a position which does not have an opposite surface. The prohibited area generator 1006 eliminates the coordinates of such prohibited space from the memory unit 1002. This step may be omitted.

Step S32: The prohibited area generator 1006 extracts the part information of each part from among the information read fro the memory unit 1002.

Step S33: The prohibited area generator 1006 calculates the coordinates of the axially symmetrical region centered on the bend line of the projection of each part the trough fold surface for each part positioned on the trough fold surface. The axially symmetrical region is a region output by the output unit 1008 as a layout prohibited area. The prohibited area generator 1006 also may write the prohibited area data which includes the calculated coordinates to the memory unit 1002.

Step S34: The calculated regions are spaces configuring the projection surface on the trough fold surface, and the prohibited area generator 1006 calculates the coordinates of the space having at least the same height as the part. In this way, a prohibited space having the calculated coordinates rises from the flexible printed circuit board by subtracting the height H of the part from the spacing D of the opposite surface (D-H) when the flexible printed circuit board is bent. Parts having a height which does not exceed (D-H) may be arranged in the layout prohibited area. Prohibited space data which include the coordinates of the calculated prohibited space are written to the memory unit 1002. Other information, such as part name and the like are included in the prohibited space data.

In this way the prohibited space and layout prohibited area coordinates are calculated and written to the memory unit 1002 based on the part position, size, bend position of the printed circuit board and the like.

3-3 Bend Position Modification Process

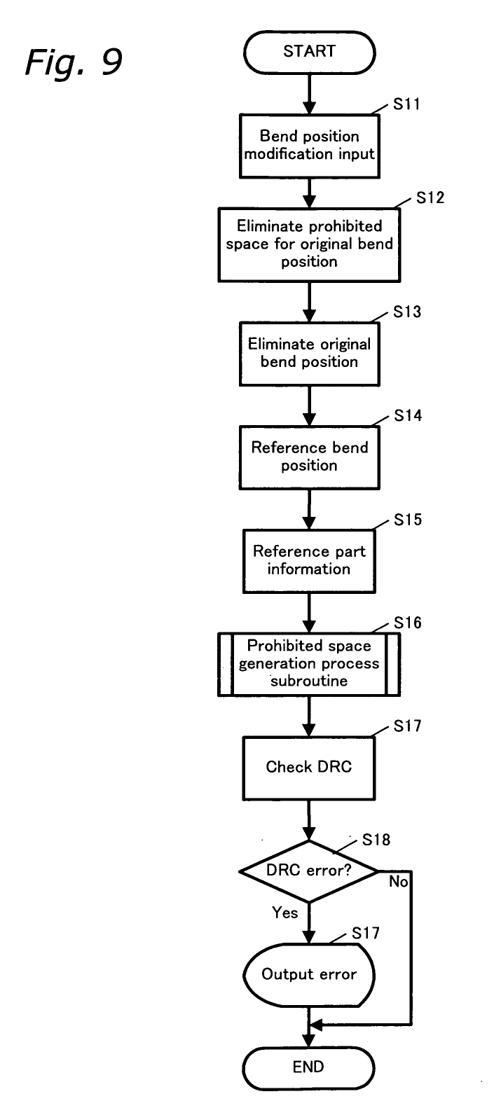

FIG. 9 is a flow chart showing an example of the flow of the bend position modification process.

Step S11˜S13: When the bend position input unit 1005 receives the bend position modification (S11), the prohibited area generator 1006 eliminates the prohibited space data from the memory unit 1002 (S12). Then, the bend position input unit 1005 eliminates the bend line information related to the bend position before the modification (S13).

Steps S14˜S19: Thereafter, the executed process is identical to the main routine based on the new input bend line information.

In this way, the prohibited space and layout prohibited areas are generated and output automatically in accordance with the previously input bend line information.

3-4 Prohibited Area Generation Process

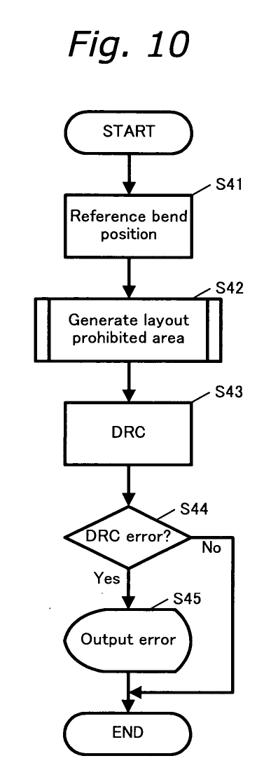

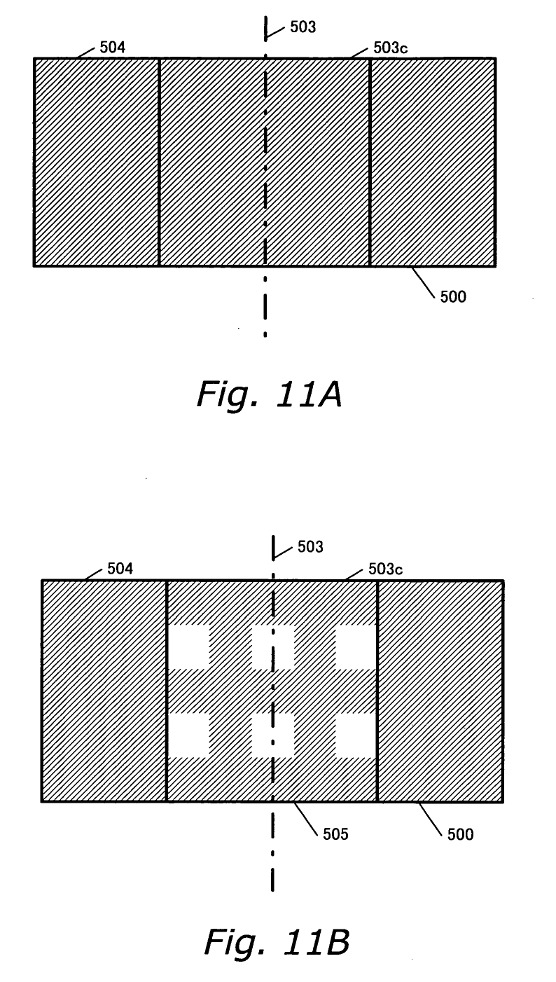

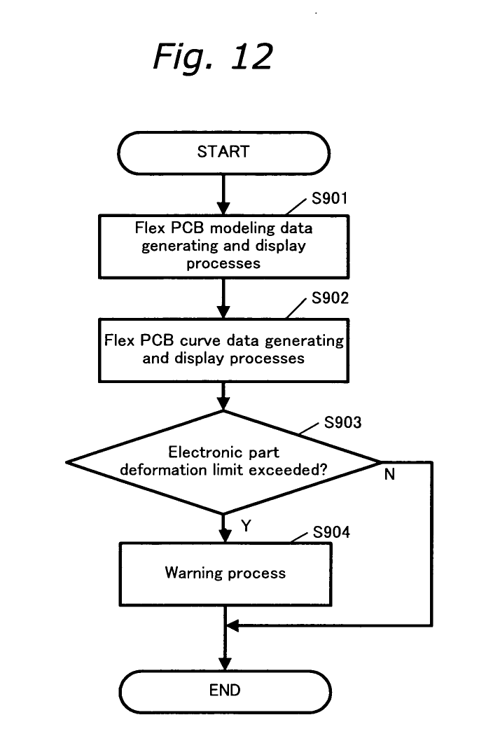

FIG. 10 is a flow chart showing an example of the flow of the prohibited area generation process for generating a layout prohibited area based on the prohibition information. The following process is started when a new bend position is input from the bend position input unit 1005.

Step S41: The prohibited area generator 1006 reads the input bend line information from the memory unit 1002.

Step S42: The prohibited area generator 1006 reads the prohibition information from the memory unit 1002. The prohibited area generator 1006 generates a specific layout prohibited area which is axially symmetrical to the bend position based on the read prohibition information. The prohibited area generator 1006 writes the prohibited area data which include the part names and coordinates defining the layout prohibited area to the memory unit 1002.

Step S43: The determination unit 1007 compares the part information and the prohibited area data, and compares the layout prohibited area for interference of parts. The layout prohibited area defined by the specific prohibited area data may be, for example, a part prohibited area representing the layout prohibition of a part, bend prohibited area of the wiring pattern representing where a bend is prohibited in the wiring pattern, via hole prohibited area representing via hole placement prohibition, planar beta wiring prohibited area representing where beta wiring is prohibited on a plane and the like.

Prohibition conditions for generating the layout prohibited area may be specified, for example, as “a range of 5 mm from the bend position”.

Steps S44˜S45: When the determination unit 1007 determines there is interference between the part information and the layout prohibited area (S44), the output unit 1008 outputs an error message (S45). When it is determined there is no interference, this process ends. In this way, the layout prohibited area can be generated based upon the prohibition information in response to the input of the bend position.

### Other Embodiments

(A) The prohibited area generator 1006 may convert the planar beta wiring overlapping the prohibited area in which the beta wiring is prohibited to grid wiring data. Such a situation is shown in FIG. 11a. FIG. 11a shows a planar beta wiring prohibited area 503c three-dimensionally overlapping a planar beta wiring 504. FIG. 11b is a plane diagram showing the partial plane beta wiring 504 overlapping the beta wiring prohibited area 503c. Since the layout prohibited area which prohibits the layout of planar beta wiring and the layout prohibited area which prohibits the grid wiring data wiring do not necessarily overlap, there is increased freedom of design for conversion.

(B) Although the bend line of the printed circuit board has been described as 90 degrees relative to the bend edge in the previous embodiment, the bend line may be similarly formed at another angle, such as 45 degrees relative to the bend edge.

(C) The program which executes the previously described method, and the computer readable recording medium for recording the program are included within the scope of the present invention. The recording medium may be, for example, a floppy disk, hard disk, CD-ROM, MO, DVD, DVD-ROM, DVD-RAM, BD, and semiconductor memory.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention are provided for illustration only, and not for the purpose of limiting the invention as defined by the appended claims and their equivalents.

1. A device for computer aided design of flexible printed circuit boards, comprising:
a memory unit configured to store parts data, the parts data including at least the positions of a first part and a second part arranged on a flexible printed circuit board as well as the heights thereof;
a prohibited space generating unit that is configured to generate a prohibited space based upon the position of the first part on the flexible printed circuit board, a bend position on the flexible printed circuit board, and the parts data for the first part stored in the memory unit;
a determination unit configured to determine whether or not a design standard violation has occurred based upon the space on the flexible printed circuit board occupied by the second part on the flexible printed circuit board, and the prohibited space; and
an error output unit configured to output an error notification in accordance with the determination result of the determination unit.

2. The device for computer aided design of claim 1, wherein the prohibited space includes a space which will be occupied by at least a portion of the first part when the flexible printed circuit board is bent at the bend position.

3. The device for computer aided design of claim 1, wherein the prohibited space generating unit determines the position of the prohibited space based on the direction in which the flexible printed circuit board is to be bent.

4. The device for computer aided design of claim 1, wherein the error output unit further outputs data concerning the prohibited space.

5. The device for computer aided design of claim 1, further comprising:
a bend position receiving unit configured to receive an addition to and/or modification of the bend position on the flexible printed circuit board;
wherein the prohibited space generating unit updates the previously generated prohibited space based on the updated bend position; and
the determination unit determines whether or not a design standard violation has occurred based upon the updated prohibited space.

6. The device for computer aided design of claim 1, further comprising:
a part position receiving unit configured to receive specifications of new part layout positions on the flexible printed circuit board;
wherein the determination unit determines the space occupied by a new part on the flexible printed circuit board, and whether or not a design standard violation has occurred, based upon the pre-existing prohibited space and the space occupied by the new part.

7. The device for computer aided design of claim 1, wherein the prohibited space generating unit generates a prohibited layout area at the position on the flexible printed circuit board at which the generated prohibited space is projected.

8. The device for computer aided design of claim 1, wherein the memory unit further stores one or more prohibition conditions which prohibit the layout of a specific type of part; and
the prohibited space generating unit further generates a prohibited area which prohibits the layout of a specific type of part on the flexible printed circuit board based upon the one or more prohibition conditions and the bend position.

9. A method for computer aided design of flexible printed circuit boards, the method comprising the steps of:
storing parts data that includes at least the positions of a first part and a second part arranged on a flexible printed circuit board as well as the heights thereof;
generating a prohibited space based upon the position of the first part on the flexible printed circuit board, a bend position on the flexible printed circuit board, and the parts data for the first part stored in the memory unit;
determining whether or not a design standard violation has occurred based upon the space on the flexible printed circuit board occupied by the second part on the flexible printed circuit board, and the prohibited space; and
outputting an error notification in accordance with the determination result of the determination unit.

10. A computer program product being used to direct a computer to function as a device for computer aided design of flexible printed circuit boards, comprising:
a memory unit configured to store parts data, the parts data including at least the positions of a first part and a second part arranged on a flexible printed circuit board as well as the heights thereof,
a prohibited space generating unit that is configured to generate a prohibited space based upon the position of the first part on the flexible printed circuit board, a bend position on the flexible printed circuit board, and the parts data for the first part stored in the memory unit;
a determination unit configured to determine whether or not a design standard violation has occurred based upon the space on the flexible printed circuit board occupied by the second part on the flexible printed circuit board, and the prohibited space; and
an error output unit configured to output an error notification in accordance with the determination result of the determination unit.
